(19) United States
(12) Patent Application Publication
(10) Pub. No.: US 2015/0203390 A1
(43) Pub. Date: Jul. 23, 2015

(54) NEW WASTEWATER TREATMENT AND SOLIDS REDUCTION PROCESS

(71) Applicant: Mohammad Taghi DANESHVAR, Little Bay, NSW (AU)

(72) Inventor: Mohammad Taghi Daneshvar, Little Bay (AU)

(21) Appl. No.: 14/420,864

(22) PCT Filed: Mar. 27, 2013
(86) PCT No.: PCT/AU2013/000346

§ 371 Date: Feb. 10, 2015

(30) Foreign Application Priority Data
Mar. 27, 2012 (AU) 2012901238

(51) Int. Cl. C02F 3/30; C02F 3/12; C02F 3/10

(52) U.S. Cl. CPC C02F 3/301; C02F 3/305; C02F 3/10; C02F 3/1273; C02F 2303/02

(57) ABSTRACT

A wastewater treatment method and process returns the whole excess sludge mixes it with the influent wastewater. The mixed flow is introduced in distributed in the bottom of a treatment tank. High turbulence aeration is done in the middle or upper parts of the treatment tank. Anoxic, anaerobic, facultative and aerobic zones are formed while the mixed flow is travelling from bottom of the treatment tank to the top. Due to futile cycle around the aeration and facultative zone right beneath the aeration the excess biological sludge production is eliminated. This process also can remove odor and can denitrify nitrate. There is a new type of packing media with high specific surface area without clogging that has been introduced and described in this invention. The present invention can be used for different application including domestic or industrial wastewater treatment, large or small. The described packing media can be used in different wastewater treatment plants or in aquaculture and cooling, contact or stripping towers.

### INTRODUCTION

The present invention concerns a process and attached growth media for treating wastewater. The process particularly includes a step of biological wastewater treatment which eliminating or greatly reducing excess biological sludge production. The invention may find application in a range of wastewater treatment plants from small on-sites package plants up to large domestic or industrial wastewater treatment plants. It can be used as a standalone total treatment or can be combined with other steps. It also can be used as a mean to upgrade the existing plants to increase the capacity and/or quality of the treatment or to reduce or eliminate the biological excess sludge production of such plants.

### BACKGROUND

Water is the most vital thing for life. It is more vital than air as some of the living things do not need air or even oxygen in any form to survive. Water can easily dissolve impurities including, organic matters and will become polluted. Almost every water usage will add impurities to water and produce wastewater. How to remove these impurities in an efficient way to prevent the spread of the pollutants to the wider environment or to reuse the water has been a major challenge in recent centuries in general and especially during recent decades. The standard practice to remove organic pollutants from water or in more common word wastewater treatment is biological treatment. One of the side effects of biological treatment is the production of excess sludge where it is a source of pollution by itself and needs further treatment and disposal steps. These steps incur a high investment and operation costs.

In recent decades there has been increasing interests in the research and technology towards reducing excess biological sludge while producing good quality effluent.

It is the object of the present invention to perform the biological treatment in a high rate and compact setup while reducing or eliminating the problem of excess sludge and solids production with the extra benefits of nitrogen removal and odour reduction.

### BRIEF DISCRIPTION OF THE INVENTION

The Invention is a simple yet very advanced wastewater treatment process which can uses unique packing medias that enhance attached microbial growth to large surface areas. The aerobic section of this process can uses Super Aerators as aeration units that cover with high efficiency a large area of the bioreactor.

The Invention includes in its overall ensemble many flexibilities in handling the treatment of a diverse type of industrial and sanitary wastewaters.

The process can be used in different configurations such as with the packing media or without the packing media or as a stand alone treatment process or in combination with other processes or can be used in the side stream of a treatment plant to reduce the excess sludge production or as a solids reduction remedy and or to increase the treatment capacity or to add/increase the Nitrogen removal at the same time.

Figure F-1 shows the basic multi zone bioreactor. As can be seen influent wastewater along with the return sludge is introduced and distributed at the bottom of the relatively deep bioreactor. The aeration is done at the middle or at the upper part of the bioreactor. As the mixture of the influent wastewater and the returned sludge is moving upward from the bottom of the multi zone bioreactor, different zones are forming due to the availability of Nitrate and Oxygen. If Nitrate is present then the first zone at the bottom will be anoxic where Nitrate is getting utilized by microorganisms along with carbon sources thus N2 gas is generated. To increase the rate of denitrification, packing media can be placed at the bottom part of the bioreactor to increase the biomass populations there. After all Nitrates are consumed, due to lack of Oxygen anaerobic zone is formed. At this zone fat and other complex organic molecules break into simpler forms such as fatty acids that are easier to be oxidized later on at the aerobic zone.

Just beneath the aeration zone there is a zone that is neither aerobic nor anaerobic. Facultative bacteria are dominating in this zone. Aerators' turbulence will pull and push the aerobic and anaerobic bacteria into opposing zones and into facultative zone. Aerobic and anaerobic bacteria die off when in opposing zones.

Facultative bacteria consume the dead microorganisms and aerobic bacteria. At the other hand the resulting stress due to the turbulent movement of cells between different conditions and the rapid and recurring changes in the oxidation reduction potentials of their environment initiate futile cycle which cause uncoupling the energy and growth cycle and will lead to a state of high energy production instead of new cell production. These conditions can lead to the total and/or partial elimination of excess biological sludge production.

H2S is usually generated at the anaerobic zone and it is the main source of odor. Sulfide will turn into Sulfate in the upper aerobic zone hence the odor causing substance is eliminated and odor is removed.

In the upper part of the tank where the aeration is taking place, packing media for attached growth can be used to ensure the existence of a large microorganisms population to utilize the aeration and the resultant dissolved Oxygen in a maximum fashion.

As mentioned before, the process can work with or without packing media. Packing media is better to be used in the aerobic upper zone to ensure the maximum use of the aeration but it can also be used at the bottom anoxic and/or anaerobic zones when it is needed to increase the rate. Figure F-2 shows a bioreactor that only have the packing media in he aerobic zone.

In the case that the influent has a very high Nitrate content and low carbon source then a carbon source such as raw wastewater can be added to the flow to the bottom of the bioreactor as shown in Figure F-3. This is specially applicable if the process is used to denitrify the treated effluent from a treatment process which does not have a denitrification stage. By using multi zone bioreactor the excess sludge and solids generated in that treatment plant can be reduced or eliminated while removing Nitrate. It also increases the capacity of the treatment plant by utilizing some of the raw wastewater as the carbon source.

In the case that the influent has a very high Nitrate content and low carbon source then a carbon source such as raw wastewater can be added to the flow to the bottom of the bioreactor as shown in Figure F-3. This is specially applicable if the process is used to denitrify the treated effluent from a treatment process which does not have a denitrification stage. By using multi zone bioreactor the excess sludge and solids generated in that treatment plant can be reduced or eliminated while removing Nitrate. It also increases the capacity of the treatment plant by utilizing some of the raw wastewater as the carbon source.

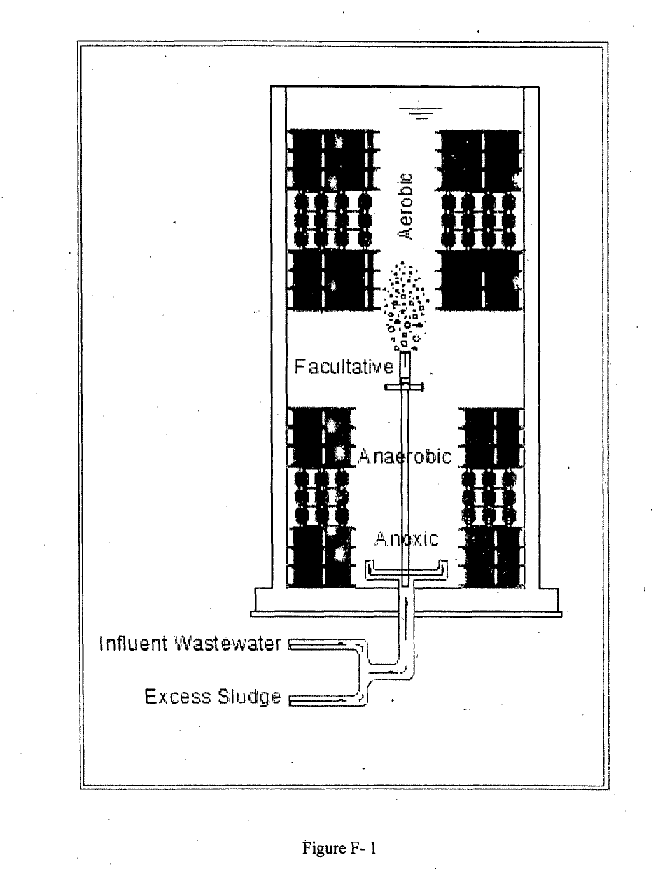

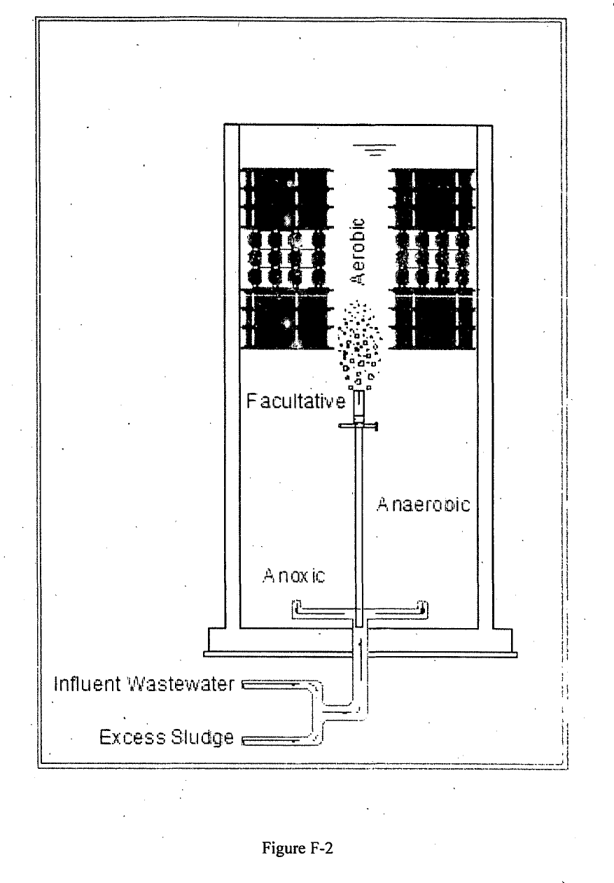

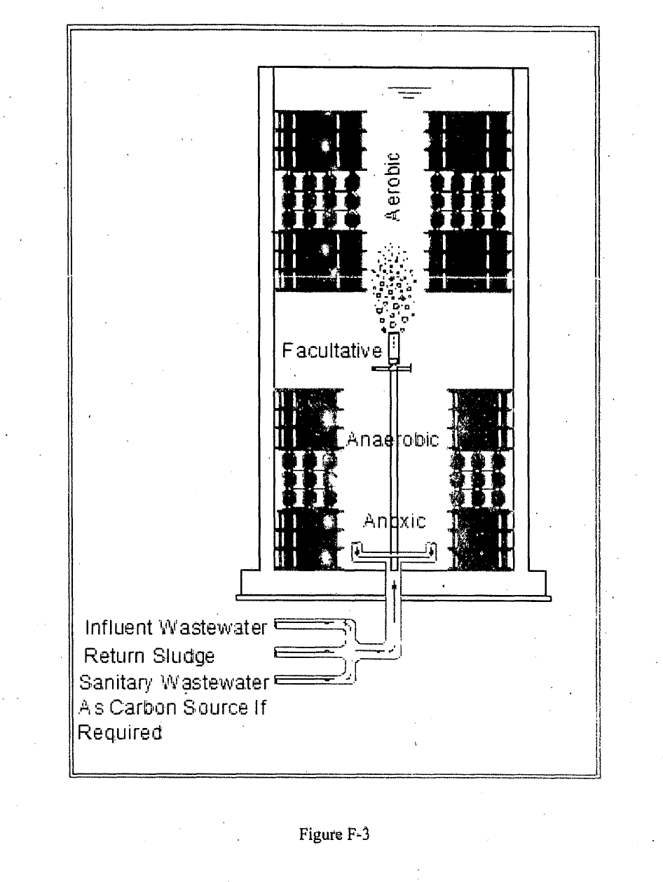

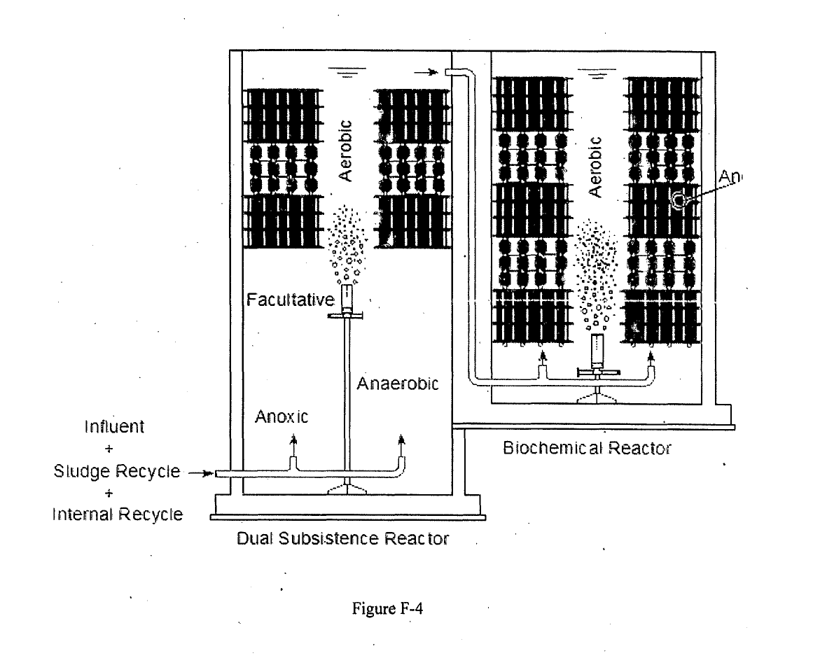

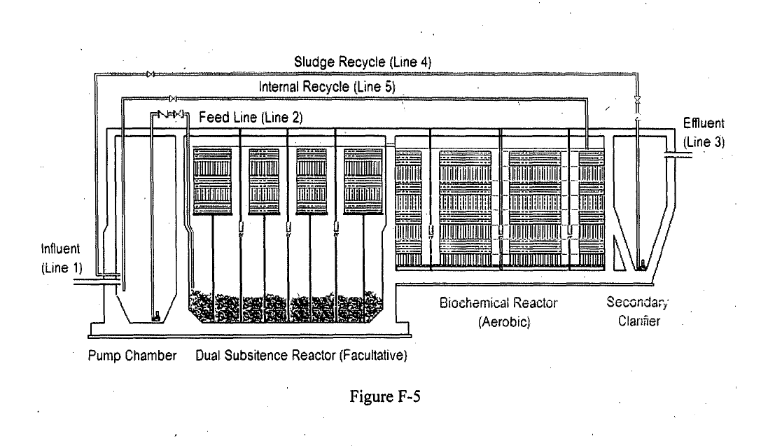

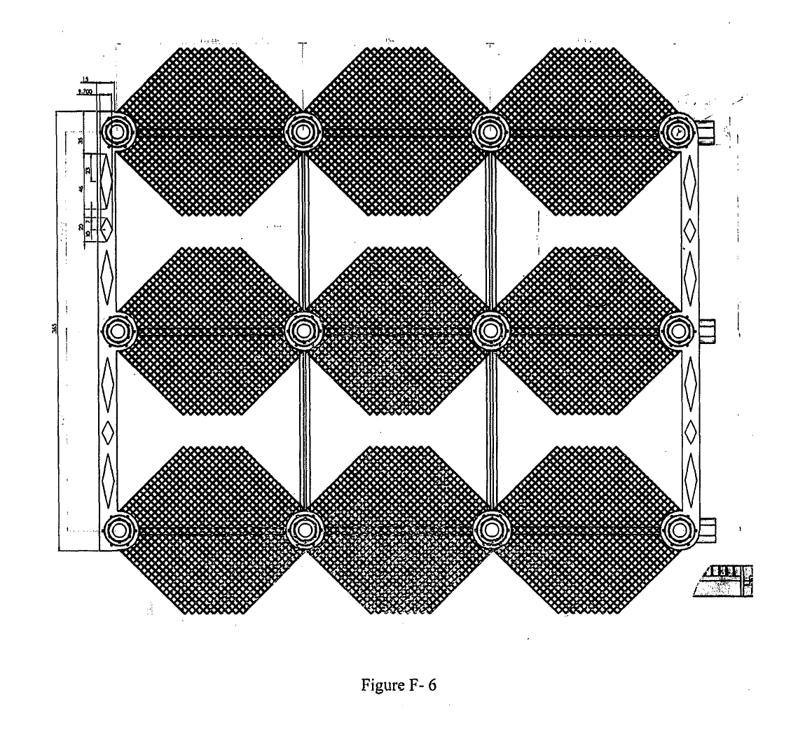

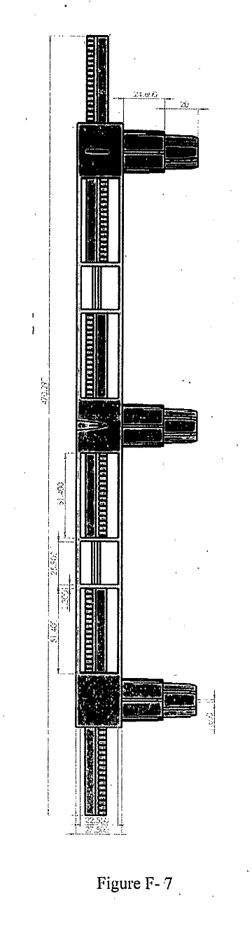

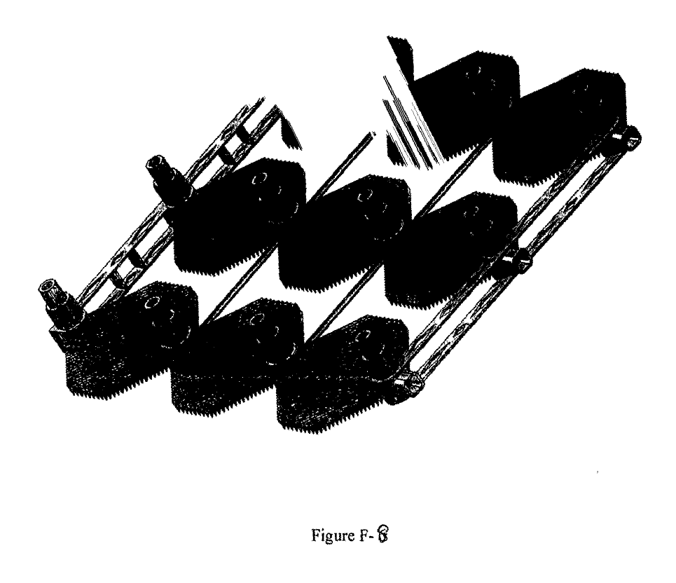

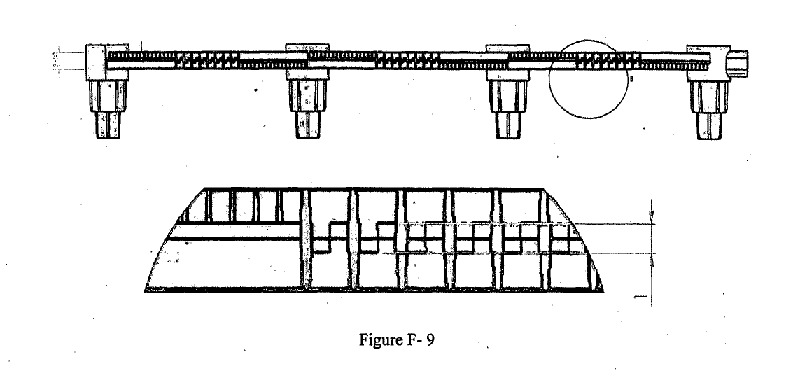

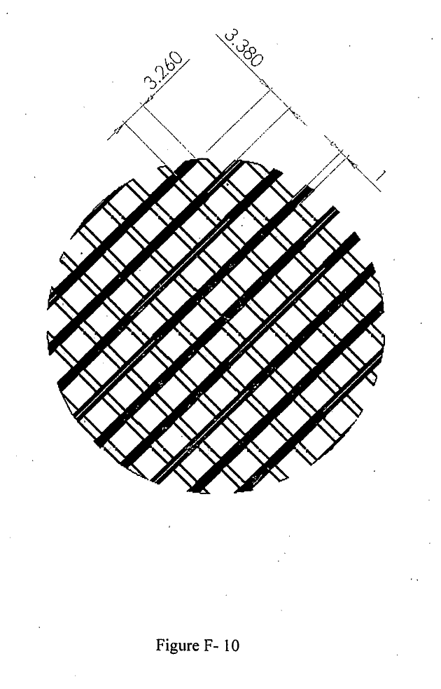

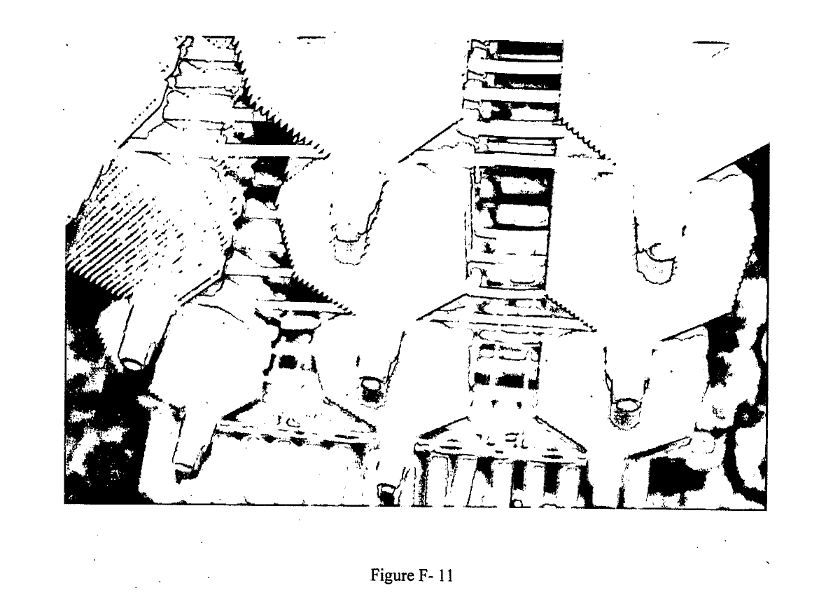

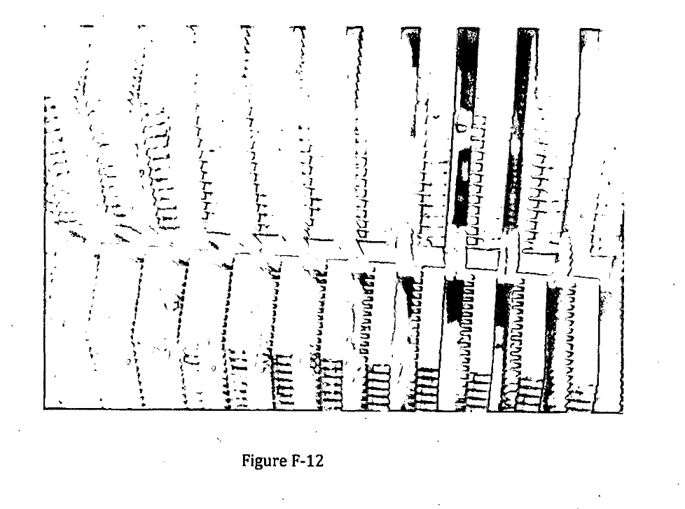

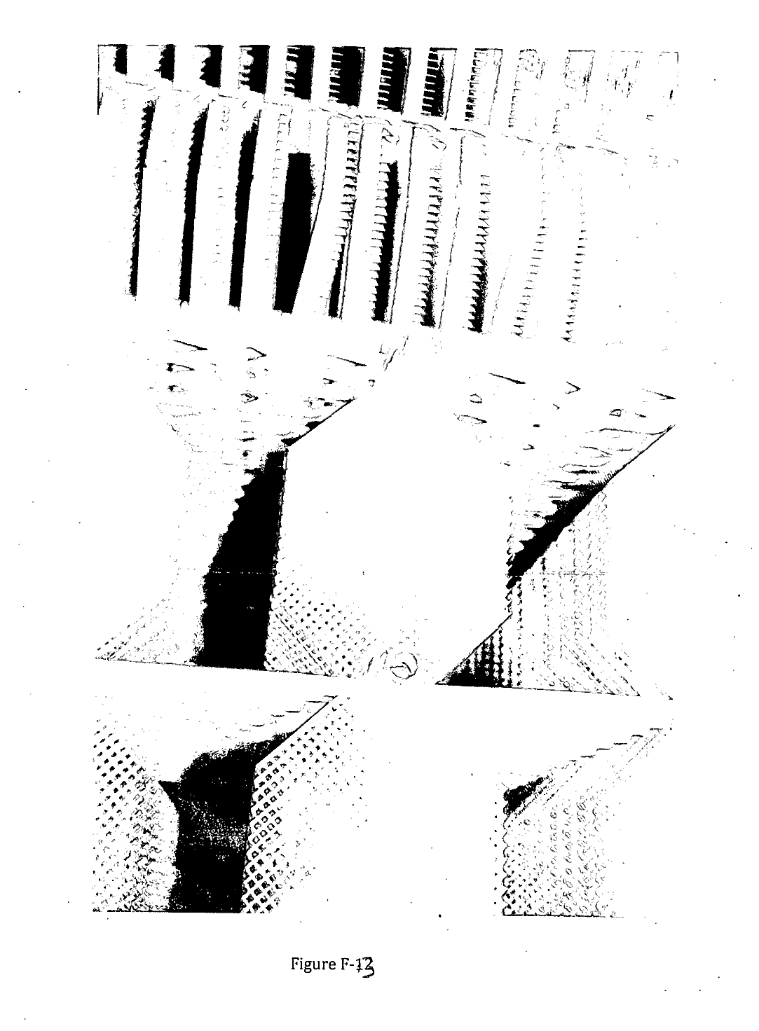

Two or more multi zone bioreactor can be used in series for high COD wastewaters to ensure the desired treatment level to meet the standards or to reuse the water. It is also advisable to use an aerobic bioreactor after the multi zone bioreactor/s especially if Nitrogen removal is intended to ensure the nitrification to turn the ammonia Nitrogen into Nitrate form. Nitrate will turn into N2 gas when it is returned into the bottom of the multi zone bioreactor along with the returned sludge or in a separate internal recycle. Figure 4 is showing a Multi-zone bioreactor (a) that is followed by an aerobic bioreactor (b). In aerobic bioreactor (b) packing media can be used to increase the microorganisms' population in the attached growth form. The connection between the Multi-zone bioreactor (a) and the aerobic bioreactor (b) should be in a way that short circuit in the aerobic bioreactor is avoided. The follow into the aerobic bioreactor (a) can be on top or bottom of the aerobic bioreactor(a). Generally as the aeration provides good mixing short circuit could not be formed even if the flow is enters the aerobic bioreactor (a) on the top unless the tank is small or narrow and the distance between the flow in and out of the aerobic bioreactor is very short.

In the final stage to separate the suspended solids from the effluent to have a clear effluent settling tanks or other means like membranes or micro-strainers and micro-screens can be used.

The Prefer Method to Implement the Invention

Figure F-5 shows one configuration that can be used to treat sanitary and many industrial wastewaters. In this configuration influent wastewater (line 1) enters a wet-well or equalization tank (pump chamber) based on the wastewater conditions. Return sludge that is separated from the effluent in a settling tank or in a membrane or filtration process (line 4) is returned into same pump chamber. Some of the returned sludge (line 4) can be returned into the aerobic bioreactor if the MLSS there needs to be controlled. The mixture (line 2) then pumped into the bottom of the Multi-zone bioreactor (facultative) and is distributed there. The wastewater after undergoing different treatments in the Multi zone bioreactor (facultative) is flowing from the top of the bioreactor into the adjacent aerobic bioreactor. An Internal recycle (line 5) brings back some of the nitrified water into the pump chamber. Aeration is done in the upper part of the Multi zone bioreactor and in the bottom of the aerobic bioreactor. Water after treated in the aerobic bioreactor is flowing into the settling tank where is looses its solids and clear water is disinfected or filtered or can go through other processes based on the usage of the treated water. Alternatively membrane modules can be used alone or in conjunction with micro-strainers or micro-screens to separate solids from the water. Separated solids are returned to the inlet or pump chamber. Submerged membranes can be used in the aerobic treatment if it is desired then the internal recycle (line 5) is only needed to bring the solids back into the inlet or pump chamber and to ensure a stable concentration of the suspended solids in the membrane chamber or in the aerobic bioreactor.

To maximize the efficiency of the treatment, a packing media with high specific surface area and a rough surface to encourage a rapid bacteria growth in the form of biofilm is placed inside bioreactor/s. The packing media should be also of non clogging nature. Although different packing media can be used but a specific media with high specific surface area is designed that works better and it is self cleaning and does not clog. This packing media can be molded of different plastics. Special powders or fillers can be added to the polymer to increase the microscopic surface area and encourage microbial growth on the surface. Figure F-6 shows the special design of this packing media. As it is shown in Figure F-7, Figure F-8 and Figure F-9, each piece is supplied with female connectors in one side and male connectors in the other side. Each piece sits in the back of the other piece to assemble and form a block. Figure F-12 shows a photo of inserted pieces together. Figure F-7, Figure F-8, Figure F-9, and Figure F -10 show different angel views and details of the said piece. Figure F11 and Figure F-12 show how the assembled block sits on top of each other. Each layer sits on top the other layer with 90 degree turn. This way the channels to carry away the sloughed and peeled pieces of biofilm are crossed in each layer to maximize the mixing and prevent channeling.

The above describes only the main embodiment of the present invention and modification, obvious to those who are skilled in the art, can be made thereto without departing from the scope and spirit of the present invention.

### INDUSTRIAL APPLICABILITY

The method of present invention can be applied to any form of biological wastewater treatment plants be it small or large, domestic or industrial. It can be used to make new plants or can be used in conjunction of the existing plants to increase the capacity or quality of the effluent or to decrease or eliminate the excess biological sludge production or all or some of the above together.

1-54. (canceled)

55. A process for treating wastewater or excess biological sludge comprising introducing wastewater mixed with the returned sludge and/or the excess biological sludge into the bottom of a bioreactor or biological treatment tank by a way of distribution.

56. The process of claim 55 wherein the said tank in has a mean of aeration in the middle or upper part of it.

57. The process of claim 55 wherein the said aeration cause turbulance.

58. The process of claim 55 wherein the said aeration circulating the content around it between upper and lower spaces of the said aeration.

59. The process of claim 55 which the said tank has no aeration or oxygen in the lower part.

60. The process of claim 55 wherein is the condition of lower part of the said tank or bioreactor is anoxic and/or anaerobic.

61. The process of claim 55 wherein the condition below the said aeration is facultative.

62. The process of claim 55 wherein the condition above the said aeration is aerobic.

63. The process of claim 55 wherein the flow leaves the said treatment tank from the top of it.

64. The process of claim 55 wherein the overall flow inside the said tank is from bottom to the top of the said tank.

65. The process of claim 55 wherein the odorous agents that is generated in the anaerobic conditions below the said aeration is oxidized in the top aerobic part of the said treatment tank.

66. The process of the claim 55 where the lower part of said treatment tank can be anoxic if Nitrate is present in the in the said incoming flow to the bottom of the said treatment tank.

67. The process of claim 66 wherein the Nitrogen gas which may be generated in the said anoxic zone will be stripped out by said aeration.

68. The process of claim 55 wherein futile cycle and uncoupling of the growth and energy cycle taking place in microorganisms caught in the said turbulant circulation flow around the said aeration passing through different oxidation reduction potentials.

69. The process of claim 55 wherein the said uncoupling reducing or eliminating the excess biological sludge production.

70. The process of claim 55 wherein the said facultative zone below the said aeration is contributing to the said elimination or reduction in excess sludge production.

71. The process claim 55 wherein the complex organic compounds breaks into simpler forms in the anaerobic zone beneath the said facultative zone and below the said aeration in the said treatment tank.

72. The process claim 55 wherein the organic solids along with oil and fat undergo hydrolysis and can break into simpler forms in the anaerobic zone beneath the said facultative zone and below the said aeration in the said treatment tank

73. The process of claim 55 wherein the said packing media for attached growth can be placed in the said aeration zone on the upper part of the said treatment tank to increase the rate of aerobic treatment and maximise the use of the oxygen dissolved in the upper part content of the said treatment tank by the said aeration.

74. The process of claim 73 wherein the said packing media will maximize the benefit of turbulance generated by the said aeration.
